(19) United States
(12) Patent Application Publication
(10) Pub. No.: US 2024/0407420 A1
(43) Pub. Date: Dec. 12, 2024

(54) PLANT PROTEIN-STARCH FILMS

(71) Applicant: XAMPLA LIMITED, Cambridge, Cambridgeshire (GB)

(72) Inventors: Polly Helena Ruth Keen, Cambridge, Cambridgeshire (GB); Hugo Thomas Barroux, Cambridge, Cambridgeshire (GB); Georgios Gkotsis, Cambridge, Cambridgeshire (GB); Marc Rodriguez Garcia, Cambridge, Cambridgeshire (GB); Nigel Patrick Sommerville-Roberts, Cambridge, Cambridgeshire (GB)

(21) Appl. No.: 18/704,514

(22) PCT Filed: Nov. 4, 2022
(86) PCT No.: PCT/EP2022/080873

§ 371 Date: Apr. 25, 2024

(30) Foreign Application Priority Data
Nov. 5, 2021 (EP) 21386068.7

(51) Int. Cl. A23P 20/20; A23J 3/14; A23L 23/10; A23L 29/212; A23P 20/10; B65B 11/00; B65B 25/00; B65D 65/42; C11D 17/04

(52) U.S. Cl. CPC A23P 20/20; A23J 3/14; A23L 23/10; A23L 29/212; A23P 20/105; B65B 11/004; B65B 25/001; B65D 65/42; C11D 17/044

(57) ABSTRACT

The present invention relates to a film comprising greater than or equal to 50 wt % of a combination of a plant protein and starch based upon the total weight of the film at 55% relative humidity and 22° C., wherein the weight ratio of starch to plant protein is in the range 0.5:1 to 30:1, and wherein the plant protein has been pre-treated with an organic acid.

### FIELD OF THE INVENTION

The present invention relates to films comprising a plant protein and starch, and to methods for preparing the films. The present invention also relates to uses of the films and to methods involving the film, including to coat or enclose a product. The present invention also relates to a film-forming composition and to films obtained therefrom.

### BACKGROUND

There is an increasingly urgent need to reduce the environmental impact of many day-to-day activities and to reduce the amounts of non-renewable resources involved in these activities. An example of this is the increasing use of biodegradable packaging to replace conventional plastics such as polyethylene and polypropylene (e.g. edible films for use in packaging of foodstuffs). Starches are especially useful materials due to their renewable source and low cost.

In this regard, particular focus has been made on the development of water soluble/water dispersible films, and starches have been found to be very useful materials for this purpose. However, the mechanical properties of starch films are dependent on the surrounding humidity and temperature conditions. This makes production scale-up more complex and leads to a narrow window of use when used to package a consumer product. Furthermore, starch films tend to have a low tensile strength, meaning that they can be brittle thereby limiting their usefulness as a packaging film.

A particular problem for starch-based films is that starch is sensitive to low temperatures due to retrogradation. Packaging of foodstuffs can often be subjected to low temperatures when the packaged foodstuff is stored in a fridge. This has meant that it has not been possible to develop commercial films containing significant amounts of starch that are robust enough to withstand all of the conditions that may be required for foodstuff packaging. However, the low cost and ready availability of starch means that it is still a desirable material to incorporate into such films.

Accordingly, there exists a need to develop starch-based water-soluble/water dispersible films that have sufficiently robust mechanical properties for them to be used as packaging films, including being handled in a manufacturing process and able to survive transportation and storage at low temperatures. A preferred feature is for foodstuff packaging to be edible, so as to further minimise waste and increase consumer convenience.

### SUMMARY OF THE INVENTION

Viewed from a first aspect, the present invention provides a film comprising greater than or equal to 50 wt % of a combination of a plant protein and starch based upon the total weight of the film at 55% relative humidity and 22° C. C, wherein the weight ratio of starch to plant protein is in the range 0.5:1 to 30:1, and wherein the plant protein has been pre-treated with an organic acid.

Preferably, the film of the first aspect of the present invention comprises:
a first layer comprising starch; and
a second layer comprising a plant protein, wherein the plant protein has been pre-treated with an organic acid;
wherein the second layer is in contact with a first surface of the first layer.

Viewed from a further aspect, the present invention provides a process for preparing a film as hereinbefore described, comprising the steps of:
(i) mixing the starch in water, optionally with sonication, to form a starch mixture;
(ii) dissolving the plant protein in water and an organic acid, optionally with sonication, to form a protein solution;
(iii) mixing the starch mixture and the protein solution to form a film-forming composition; and
(iv) forming the film-forming composition into a film comprising greater than or equal to 50 wt % of a combination of a plant protein and starch based upon the total weight of the film at 55% relative humidity and 22° C.

Viewed from a further aspect, the present invention provides a process for preparing a film as hereinbefore described, comprising the steps of:
(i) mixing the starch in water, optionally with sonication, to form a starch mixture;
(ii) forming the starch mixture into a first layer on a surface;
(iii) dissolving the plant protein in water and an organic acid, optionally with sonication, to form a protein solution; and
(iv) forming the protein solution into a second layer on a first surface of the first layer, so that the film comprises greater than or equal to 50 wt % of a combination of a plant protein and starch based upon the total weight of the film at 55% relative humidity and 22° C.

Viewed from a further aspect, the present invention provides a product, preferably a foodstuff, coated with or enclosed by a film as hereinbefore described.

Viewed from a further aspect, the present invention provides a method of coating or enclosing a product, preferably a foodstuff, comprising the steps of:
(i) wrapping the product in a film as hereinbefore described; and
(ii) sealing the film around the product.

Viewed from a further aspect, the present invention provides the use of a film as hereinbefore described to coat or enclose a product, preferably a foodstuff.

A method of releasing a product coated or enclosed with a film as hereinbefore described, comprising the steps of:
(i) placing the coated or enclosed product in water; and
(ii) allowing the film to disperse, thereby releasing the product.

Viewed from a further aspect, the present invention provides a film-forming composition comprising a plant protein and starch, wherein the weight ratio of starch to plant protein is in the range 0.5:1 to 30:1 and wherein the plant protein has been pre-treated with an organic acid.

Viewed from a further aspect, the present invention provides a film obtained from a film-forming composition as hereinbefore described.

### DETAILED DESCRIPTION OF THE INVENTION

The present invention describes films that are both robust and dispersible in water. The films of the present invention are therefore useful as packaging materials as they have the strength to withstand a manufacturing process and subsequent transportation and storage, but can then disperse upon contact with water, e.g. to release the product that has been packaged. Thus, the present invention provides a film comprising greater than or equal to 50 wt % of a combination of a plant protein and starch based upon the total weight of the film at 55% relative humidity and 22° C. C, wherein the weight ratio of starch to plant protein is in the range 0.5:1 to 30:1, and wherein the plant protein has been pre-treated with an organic acid.

In the films of the present invention, the weight ratio of starch to plant protein is in the range 0.5:1 to 30:1.

In preferred films of the present invention, the weight ratio of starch to plant protein is in the range 2:1 to 27.5:1, more preferably 3.5:1 to 25:1, even more preferably 7:1 to 25:1. The combination of a low level of plant protein with starch in these weight ratio ranges has been found to impart an increased strength to the film, without negatively impacting upon the ability of the film to disperse in water.

In alternative preferred films of the present invention, the weight ratio of starch to plant protein is in the range 1:2 to 3:1, more preferably 1:1 to 2:1. The combination of a plant protein with starch in these weight ratio ranges has been found to result in surprisingly robust films.

In order to determine the total protein content in a given sample of film, the soluble nitrogen-containing fraction contained can be quantitatively measured according to the Kjeldahl method, and then the total protein content can be obtained by multiplying the nitrogen content expressed as the weight percentage of the dried product by a factor of 6.25. This method is well known to those skilled in the art.

Total starch content in a given sample of film can be determined by standard methods AOAC Method 996.11 or AOAC Method 2014.10, which employ the combined action of α-amylase and amyloglucosidase to hydrolyse the starch to glucose, followed by glucose determination with a glucose oxidase/peroxidase reagent.

Preferred films of the present invention are monolayer films. An example of such a film is depicted graphically in FIG. 1a.

Alternative preferred films of the present invention are multilayer films. Thus, a preferred film of the present invention comprises:
a first layer comprising starch; and
a second layer comprising a plant protein, wherein the plant protein has been pre-treated with an organic acid;
wherein the second layer is in contact with a first surface of the first layer; wherein the film comprises greater than or equal to 50 wt % of a combination of a plant protein and starch based upon the total weight of the film at 55% relative humidity and 22° C.; and the weight ratio of starch to plant protein is in the range 0.5:1 to 30:1.

An example of such a multilayer film is depicted graphically in FIG. 1b, wherein layer (1) is the first layer and layer (2) is the second layer.

In preferred films of the present invention, the first layer further comprises a plant protein, wherein the plant protein has been pre-treated with an organic acid.

In preferred films of the present invention, the second layer further comprises starch.

In preferred films of the present invention, the first layer further comprises a plant protein, wherein the plant protein has been pre-treated with an organic acid, and the second layer further comprises starch. As would be understood by a skilled person, the weight ratio of starch to plant protein within each of the first and second layers may be the same or different. Preferably, the weight ratio of starch to plant protein within each of the first and second layers is different. More preferably, the weight ratio of starch to plant protein within the first layer is greater than the weight ratio of starch to plant protein within the second layer.

As would be understood by a skilled person, further layers may be added to the films of the present invention.

The films of the present invention comprise a plant protein. In preferred films of the present invention, the plant protein is selected from soybean protein, pea protein, rice protein, potato protein, rapeseed protein, and/or sunflower protein, preferably selected from pea protein, potato protein, rapeseed protein, sunflower protein and/or rice protein, more preferably pea protein.

In preferred films of the present invention, the plant protein is a protein from the Fabaceae family, preferably pea protein.

Preferred films of the present invention do not comprise soybean protein and/or gluten.

In preferred films of the present invention, the plant protein source is a plant protein isolate, preferably pea protein isolate.

In preferred films of the present invention, the plant protein source is a plant flour, preferably pea flour.

In preferred films of the present invention, the plant protein source is obtained from a waste stream, e.g. a waste stream from agricultural or food production.

Preferred films of the present invention comprise 2.0 to 40 wt % plant protein based upon the total weight of the film at 55% relative humidity and 22° C., preferably 2.5 to 35 wt %, more preferably 3.0 to 30 wt %.

An organic acid is an organic compound with acidic properties, preferably a carboxylic acid. In preferred films of the present invention, the organic acid used in the pre-treatment of the plant protein is selected from acetic acid, an α-hydroxy acid, or a β-hydroxy acid. More preferably, the organic acid is selected from acetic acid, lactic acid, citric acid, malic acid, maleic acid, glycolic acid, gluconic acid, tartaric acid, β-hydroxypropionic acid, β-hydroxybutyric acid, β-hydroxy β-methylbutyric acid, 2-hydroxybenzoic acid and carnitine, or a mixture thereof, preferably acetic acid.

In preferred films of the present invention, the organic acid used in the pre-treatment of the plant protein is a volatile organic acid (i.e. those having a boiling point of less than 120° C.), preferably acetic acid. This is because volatile organic acids can be easily removed from a film-forming composition during a casting or drying step, such that the final film contains little, if any, residual organic acid.

The films of the present invention display a useful combination of properties meaning that they are robust but still dispersible in water. Without wishing to be bound by theory, it is thought that the increased strength of the films of the present invention can be attributed to the pre-treatment of the plant protein with an organic acid. This is thought to be because the plant protein unfolds in the presence of an organic acid at high temperature, such that it is more available for interaction with the starch present, e.g. via hydrogen bonding. These increased protein-starch interactions reduce the level of retrogradation of the starch, this being the cause of brittleness in conventional starch-based films.

The pre-treatment of the plant protein with an organic acid results in the plant protein having a protein secondary structure with at least 40% intermolecular β-sheet, at least 50% intermolecular β-sheet, at least 60% intermolecular β-sheet, at least 70% intermolecular β-sheet, at least 80% intermolecular β-sheet, or at least 90% intermolecular β-sheet.

For the avoidance of doubt, the pre-treatment of the plant protein with organic acid takes place prior to mixing the plant protein with starch.

Preferably, the pre-treatment of the plant protein with organic acid involves the use of an aqueous organic acid solution. More preferably, the aqueous organic acid solution has a concentration of at least 5% (v/v), preferably at least 10% (v/v), more preferably at least 15% (v/v), more preferably at least 20% (v/v), more preferably at least 25% (v/v), more preferably at least 30% (v/v), more preferably at least 40% (v/v), even more preferably at least 50% (v/v). Alternatively, the aqueous organic acid solution has a concentration of no more than 90% (v/v), preferably no more than 80% (v/v), more preferably no more than 70% (v/v). Concentrated acid solutions are dangerous to be handled at large scale.

A starch is a carbohydrate polymer. Starches consist essentially of amylose and/or amylopectin and in the native form are typically in the form of semi-crystalline granules. Sources of starch include but are not limited to fruits, seeds, and rhizomes or tubers of plants.

Some starches are classified as waxy starches. A waxy starch consists essentially of amylopectin and lacks an appreciable amount of amylose. Typical waxy starches include waxy maize starch, waxy rice starch, waxy potato starch, and waxy wheat starch.

Alternatively, some starches are classified as high amylose starches.

Modified starches are prepared by physically, enzymatically, or chemically treating native starch to change its properties. Starches may be modified, for example, by enzymes, by heat treatment, oxidation, or reaction with various chemicals.

In the films of the present invention, the starch may be a native starch or a modified starch, or a mixture thereof.

In preferred films of the present invention, the starch is selected from wheat starch, potato starch, pea starch, waxy potato starch, maize starch, waxy maize starch, high amylose maize starch, tapioca starch, cassava starch, rye starch, sorghum starch, chickpea starch, soy starch, or a mixture thereof, preferably potato starch.

In alternative preferred films of the present invention, the starch is a modified starch selected from acid-treated starch, dextrin, alkaline-modified starch, bleached starch, oxidized starch, enzyme-treated starch, maltodextrin, cyclodextrin monostarch phosphate, distarch phosphate, acetylated starch, hydroxypropylated starch, hydroxyethyl starch, starch sodium octenyl succinate, starch aluminium octenyl succinate or cationic starch, or a mixture thereof, preferably acid-treated starch.

Preferred films of the present invention comprise 30 to 70 wt % starch based upon the total weight of the film at 55% relative humidity and 22° C., preferably 40 to 65 wt %, more preferably 45 to 60 wt %.

Preferred films of the present invention comprise greater than or equal to 50 wt % of a combination of plant protein and starch based upon the total weight of the film at 55% relative humidity and 22° C., preferably greater than or equal to 55 wt %, more preferably greater than or equal to 60 wt %.

Preferred films of the present invention comprise less than or equal to 75 wt % of a combination of plant protein and starch based upon the total weight of the film at 55% relative humidity and 22° C., preferably less than or equal to 72 wt %, more preferably less than or equal to 70 wt %.

Preferred films of the present invention comprise 50 to 75 wt % of a combination of plant protein and starch based upon the total weight of the film at 55% relative humidity and 22° C., preferably 55% to 72 wt %, more preferably 60 to 70 wt %.

Preferred films of the present invention comprise 8 to 20 wt % water based upon the total weight of the film at 55% relative humidity and 22° C., preferably 10 to 15 wt %.

Preferred films of the present invention further comprise a plasticiser. Plasticisers are useful for improving film flexibility. Preferably, the plasticiser is selected from glycerol, polyethylene glycol, propylene glycol, sorbitol, mannitol, xylitol, triethyl citrate, fatty acids, glucose, mannose, fructose, sucrose, urea, lecithin, waxes, amino acids and organic acids (e.g. lactic acid, citric acid, glycolic acid, malic acid, gluconic acid or tartaric acid), or a mixture thereof, preferably glycerol.

As would be understood by a skilled person, an organic acid may be used in the pre-treatment of the plant protein and then remain to subsequently function as a plasticiser in the resultant film.

When the film is intended to package a foodstuff, the plasticiser must be suitable for human consumption. The preferred plasticisers mentioned above are all suitable for human consumption (i.e. they are food grade materials).

Preferred films of the present invention comprise 5 to 30 wt % plasticiser based upon the total weight of the film at 55% relative humidity and 22° C., preferably 10 to 25 wt %, more preferably 10 to 20 wt %, most preferred 13 to 19 wt %.

Preferred films of the present invention comprise further comprise a pigment or dye. Preferably, the pigment or dye is selected from azo-, quinophthalone-, triphenylmethane-, xanthene- or indigoid dyes; iron oxides or hydroxides; titanium dioxide; or natural dyes and mixtures thereof. Examples include patent blue V, acid brilliant green BS, red 2G, azorubine, ponceau 4R, amaranth, D+C red 33, D+C red 22, D+C red 26, D+C red 28, D+C yellow 10, yellow 2 G, FD+C yellow 5, FD+C yellow 6, FD+C red 3, FD+C red 40, FD+C blue 1, FD+C blue 2, FD+C green 3, brilliant black BN, carbon black, iron oxide black, iron oxide red, iron oxide yellow, titanium dioxide, riboflavin, carotenes, anthocyanines, turmeric, cochineal extract, chlorophyllin, canthaxanthin, caramel, betanin and Candurin® pearlescent pigments. More preferably, the pigment or dye is a food colourant, preferably a food colourant derived from plant sources, more preferably a food colourant selected from carotenoids, chlorophyllins, anthocyanins and betanin.

Preferred films of the present invention further comprise a structural reinforcement agent. The use of a structural reinforcement agent can help to improve the strength of the films. Preferably, the structural reinforcement agent is selected from cellulosic materials, including microcrystalline cellulose, micro-fibrillated cellulose including cellulose fibres extracted from the pulp of citrus fruits, microfibrous cellulose from fermentation, starch microcrystals, clays or a mixture thereof, preferably micro-fibrillated cellulose from citrus pulp.

Preferred films of the present invention comprise 0.5 to 5 wt % of said structural reinforcement agent based upon the total weight of the film at 55% relative humidity and 22° C., preferably 0.6 to 2.5 wt %.

Preferred films of the present invention further comprise a hydrophobic agent. Preferably, the hydrophobic agent is a plant-based oil, preferably a non-volatile plant-based oil, which is preferably selected from vegetable oil, rapeseed oil, canola oil, soybean oil, sunflower oil, safflower oil, corn oil, and a flavour oil, or mixtures thereof, preferably vegetable oil. Examples of flavour oils include thyme oil, basil oil, olive oil, chilli oil, rosemary oil, garlic oil, citrus oils or lavender oil.

Alternatively, the hydrophobic agent is a plant-based fatty acid, which is a saturated fatty acid or unsaturated fatty acid, or a mixture thereof. Preferably, the plant-based fatty acid is non-volatile. Preferred saturated fatty acids include caprylic acid, capric acid, lauric acid, myristic acid, palmitic acid, and stearic acid. Preferred unsaturated fatty acids include myristoleic acid, palmitoleic acid, oleic acid and linoleic acid.

Without wishing to be bound by theory, it is thought that the presence of a hydrophobic agent such as a plant-based oil or plant-based fatty acid in the films of the present invention improves the surface integrity of the films. This is thought to be because during the preparation of the film the hydrophobic agent moves to the top surface of the cast composition and thereby inhibits the early formation of a skin thereon, meaning that steam is able to more easily escape and that fewer bubbles are formed and trapped within the film once dry.

The use of a flavour oil as a hydrophobic agent in the films of the present invention offers the additional advantage that the films themselves can act as a flavour delivery means, e.g. when the film is used to package a foodstuff.

Preferred films of the present invention comprise 0.3 to 2.5 wt % of a hydrophobic agent based upon the total weight of the film at 55% relative humidity and 22° C., preferably 0.6 to 2.0 wt %, more preferably 0.7 to 1.5 wt %.

Preferred films of the present invention are suitable for human or animal consumption, i.e. the films are edible films. More preferably, the films of the present invention do not contain any ingredients derived from animal sources, making them suitable for consumption by vegetarians/vegans.

Preferred films of the present invention are digestible.

As used herein, edible refers to films that are digestible and would provide some nutritional benefit in themselves. This is in contrast to films which are safe to eat but which do not provide any nutrition themselves. An example of these latter films would be films made from HPMC, hydroxypropyl methyl cellulose, which is widely used in the pharmaceutical industry or other films based on cellulose. A characteristic of edible films is that they are inherently very rapidly biodegradable. Starch is often chemically modified to improve its cross-linking ability. Such approaches can be very effective at improving the physical properties of a starch but this very often reduces its digestibility and use as an edible material. Hence it is preferred if the starches used in these films have not been subjected to prior chemical modification other than hydrolysis.

Preferred films of the present invention do not contain chitosan.

The films of the present invention have a high dispersibility in water. This means that they can be used as a packaging material for a product that creates zero waste during end use of the product. For example, the films of the present invention could be used to package a detergent such that during the washing process the film will disperse in water to release the detergent. Alternatively, the films of the present invention could be used to package a foodstuff such that during the cooking process the film will disperse in water to release the foodstuff. Thus, in preferred films of the present invention, when 0.2 g of the film is boiled in water with agitation for 3 minutes and then poured through a 2 mm mesh sieve, 0.15 g or less of residue is collected on the sieve, preferably 0.1 g or less, more preferably 0.05 g or less. Advantageously, the residue is fully biodegradable meaning that the films do not have a negative impact on the environment.

In preferred films of the present invention, the pH of a dispersion of the film at a concentration of 1 g film in 10 g of deionised water at 25° C. is greater than 5, preferably greater than 5.5, more preferably greater than 6. This has the advantage that when the films are used to package a foodstuff the film, once dispersed, does not impart an acidic or otherwise negative taste to the foodstuff.

In preferred films of the present invention, the viscosity of a dispersion of the film at a concentration of 1 g film in 50 g of deionised water is less than 100 cps at 25° C. and 10 s⁻¹, preferably less than 90 cps at 25° C. and 10 s⁻¹, more preferably less than 80 cps at 25° C. and 10 s⁻¹. This has the advantage that the films, once dispersed, do not negatively affect the viscosity of the product, e.g. if the packaged product is a drink, the dispersed film will not cause the drink to become unduly thick and cause a negative consumer experience.

In preferred films of the present invention, the film has a tensile strength of 0.15 to 5 MPa as measured by ASTM D882-18 at 76% relative humidity and 5° C., preferably 0.17 to 3.5 MPa.

In preferred films of the present invention, the film has a break strain of 10 to 150% as measured by ASTM D882-18 at 76% relative humidity and 5° C., preferably 15 to 120%.

In preferred films of the present invention, the plant protein in the second layer has a secondary structure with at least 40% intermolecular β-sheet content, at least 50% intermolecular β-sheet content, at least 60% intermolecular β-sheet content, at least 70% intermolecular β-sheet content, at least 80% intermolecular β-sheet content, or at least 90% intermolecular β-sheet content, as measured by FTIR when the second layer is prepared on an inert surface, e.g. a glass surface.

In order to investigate the secondary structure of the plant protein in the second layer, Fourier-transform infrared (FTIR) analysis was performed. FTIR spectroscopy data were collected using FTIR VERTEX 70 spectrometer (Bruker) with a diamond attenuated total reflection (ATR) element. The second layer comprising the plant protein needs to be in direct contact with the diamond ATR cell. The data was collected using 128 scans at 4 cm−1 resolution with background subtractions. For the structural analysis of proteins, the spectra were smoothed with a 2nd order and seven-point window Savitzky-Golay filter and normalized. The second derivative in the Amide I band (1600-1700 cm−1) was calculated from the smoothed data to deconvolve and quantify the secondary and quaternary structural contributions. In preferred films of the present invention, the biodegradation percentage based upon O₂ consumption of the film as measured according to ISO-14851 after 28 days is 70 to 100%, more preferably 80 to 100%, even more preferably 85 to 100%.

In preferred films of the present invention, the biodegradation percentage based upon CO₂ production of the film as measured according to ISO-5 14851 after 28 days is 70 to 100%, more preferably 75 to 100%, even more preferably 80 to 100%.

The present invention also provides a film comprising a plant protein and starch, wherein the weight ratio of starch to plant protein is in the range 0.5:1 to 30:1, and wherein the film has a tensile strength of 0.15 to 5 MPa as measured by ASTM D882-18 at 76% relative humidity and 5° C. and/or a break strain of 10 to 150% as measured by ASTM D882-18 at 76% relative humidity and 5° C.

Preferred features of the film are as described above.

The present invention also provides a process for preparing a film as hereinbefore described, comprising the steps of:
(i) mixing the starch in water, optionally with sonication, to form a starch mixture;
(ii) dissolving the plant protein in water and an organic acid, optionally with sonication, to form a protein solution;
(iii) mixing the starch mixture and the protein solution to form a film-forming composition; and
(iv) forming the film-forming composition into a film comprising greater than or equal to 50 wt % of a combination of a plant protein and starch based upon the total weight of the film at 55% relative humidity and 22° C., wherein the weight ratio of starch to plant protein is in the range 0.5:1 to 30:1.

In step (i), sonication will inherently heat a solution due to the sound energy applied.

In preferred processes of the present invention, the step (i) mixing is conducted at a temperature in the range 70 to 100° C., preferably 85 to 95° C.

In preferred processes of the present invention, the step (ii) dissolving is conducted at a temperature in the range 70 to 100° C., preferably 85 to 95° C.

In a preferred process of the present invention, organic acid is removed between steps (ii) and (iii).

In preferred processes of the present invention, the step (iii) mixing is conducted at a temperature in the range 70 to 100° C., preferably 85 to 95° C.

In preferred processes of the present invention, steps (i), (ii) or (iii) further comprise sonication and/or ultrasound treatment.

In preferred processes of the present invention, step (iv) involves casting the film-forming composition onto a surface. Preferably, the surface is a pre-formed layer comprising starch or a pre-formed layer comprising a plant protein. Alternatively, the surface is a glass plate or other backing substance, like e.g. a PET carrier film. Alternatively, the surface is a moving belt, preferably a steel moving belt.

In preferred processes of the present invention, in step (iv) the film-forming composition is at a temperature in the range 50 to 95° C., more preferably 50 to 85° C.

In preferred processes of the present invention, the surface is heated. Preferably, the surface is heated to a temperature in the range 50 to 130° C., more preferably 55 to 100° C.

In preferred processes of the present invention, step (iv) further comprises heating the film in an oven, preferably at a temperature in the range 70 to 150° C.

In alternative preferred processes of the present invention, step (iv) involves extruding the film-forming composition through an orifice to form the film.

Preferred processes of the present invention further comprising an ageing step. Preferably, said ageing step involves subjecting the film to a temperature of between 1° and 35° C. for a period of 1 week.

In a preferred process of the present invention, steps (i) to (iv) are repeated to produce a multilayer film. Thus, steps (i)-(iv) can be carried out to produce a first layer and then steps (i) to (iv) can be repeated to produce a second layer on a first surface of the first layer.

The present invention also provides a process for preparing a film as hereinbefore described, comprising the steps of:
(i) mixing the starch in water, optionally with sonication, to form a starch mixture;
(ii) forming the starch mixture into a first layer on a surface;
(iii) dissolving the plant protein in water and an organic acid, optionally with sonication, to form a protein solution; and
(iv) forming the protein solution into a second layer on a first surface of the first layer, so that the film comprises greater than or equal to 50 wt % of a combination of a plant protein and starch based upon the total weight of the film at 55% relative humidity and 22° C., wherein the weight ratio of starch to plant protein is in the range 0.5:1 to 30:1.

In step (i), sonication will inherently heat a solution due to the sound energy applied

In preferred processes of the present invention, the step (i) mixing is conducted at a temperature in the range 70 to 100° C., preferably 85 to 95° C.

In preferred processes of the present invention, step (i) further comprises sonication and/or ultrasound treatment.

In preferred processes of the present invention, step (ii) involves casting the starch mixture onto a surface. Preferably, the surface is a pre-formed layer comprising starch or a pre-formed layer comprising a plant protein. Alternatively, the surface is a glass plate or other backing substance, like e.g. a PET carrier film. Alternatively, the surface is a moving belt, preferably a steel moving belt.

In preferred processes of the present invention, in step (ii) the starch mixture is at a temperature in the range 50 to 95° C., preferably 55 to 85° C.

In preferred processes of the present invention, the surface is heated. Preferably, the surface is heated to a temperature in the range 50 to 130° C., more preferably 55 to 100° C.

In preferred processes of the present invention, the step (iii) dissolving is conducted at a temperature in the range 70 to 100° C., preferably 85 to 95° C.

In preferred processes of the present invention, step (iii) further comprises sonication and/or ultrasound treatment.

In a preferred process of the present invention, organic acid is removed between steps (iii) and (iv).

In preferred processes of the present invention, step (iv) involves casting the protein solution onto the first surface of the first layer. Preferably, the first surface of the first layer is heated to a temperature in the range 50 to 95° C., more preferably 55 to 85° C.

In preferred processes of the present invention, in step (iv) the protein solution is at a temperature in the range 50 to 100° C., preferably 55 to 90° C.

The present invention also provides a product, preferably a foodstuff, coated with or enclosed by a film as hereinbefore described.

Preferably, the product is a foodstuff, a pharmaceutical product, a cleaning product, an agricultural product (e.g. an animal feed) or medication, a chemical product or a cosmetic product.

Preferably, the product is a solid product, a powdered product or a liquid product having a water activity of less than 50%.

The water activity of a material is the % equilibrium relative humidity of the material divided by 100. The % equilibrium relative humidity of a sample is measured by use of a humidity probe. Suitable equipment includes the Rotronics HC2-AW unit from Process Sensing Technologies and operated according to the instruction manual dated 31 Mar. 2016 or later. The unit should have been calibrated within one year of use according to the procedures using salt solutions as specified in the operation manual. The sample to be tested is placed in the sample cup and placed in the test unit. The humidity cell is then placed on the sample cup so as to seal the sample in the sample cup. The free water in the test sample then equilibrates with the air in the headspace above the sample and the final level of humidity in the headspace is measured by the HC2 unit and reported as % equilibrium relative humidity (eRH) at the test temperature. The % eRH is then divided by 100 to give the sample's water activity. The measurement should be carried out at temperatures between 20° C. and 25° C. to avoid temperature-dependent variability.

Preferably, the product is a solid product selected from a soup or flavouring preparation (e.g. a stock cube), a personal cleanser (e.g. a soap bar, body wash, body scrub or shampoo), a laundry detergent tablet or a dishwasher detergent tablet. More preferably, the product is a stock cube. Alternatively, the product is a laundry detergent tablet or a dishwasher detergent tablet.

Preferably, the product is a powdered product selected from a powdered food, a powdered drink, powdered milk, powdered soup, powdered hot chocolate, powdered coffee, soap flakes, and powdered shampoo. More preferably, the product is a powdered drink.

Preferably, the product is a non-aqueous liquid product which is an oil or a hair care product. More preferably, the product is a cooking oil.

The present invention also provides a method of coating or enclosing a product, preferably a foodstuff, comprising the steps of:
(i) wrapping the product in a film as hereinbefore described; and
(ii) sealing the film around the product.

Preferred products are as described above.

Preferably, step (ii) comprises heat sealing.

As would be understood by a skilled person, the sealing step requires contact between sections of film comprising starch. For example, a composite film comprising starch and plant protein can be sealed against another composite film comprising starch and plant protein, or to itself. However, if the film is a multilayer film comprising, for example, a starch layer and a plant protein layer, it is necessary to seal the starch layer to another film comprising starch, or to itself. This is because starch can melt (or gelatinise) at much lower temperatures compared to the plant protein. Residual water present in the starch layer also helps lower the melting (or gelatinisation) temperature of the starch.

The present invention also provides the use of a film as hereinbefore described to coat or enclose a product, preferably a foodstuff.

Preferred products are as described above.

The present invention also provides a method of releasing a product coated or enclosed with a film as hereinbefore described, comprising the steps of:
(i) placing the coated or enclosed product in water; and
(ii) allowing the film to disperse, thereby releasing the product.

Preferred products are as described above.

Preferably, the product is released during a cooking process.

Alternatively, the product is released during a washing process.

In preferred methods of the present invention, step (ii) further comprises stirring or shaking.

The present invention also provides a film-forming composition comprising a plant protein and starch, wherein the weight ratio of starch to plant protein is in the range 0.5:1 to 30:1 and wherein the plant protein has been pre-treated with an organic acid.

Preferred features are as described above in relation to the films of the present invention.

The present invention also provides a film obtained from a film-forming composition as hereinbefore described.

Preferred features are as described above.

### BRIEF DESCRIPTION OF THE FIGURES

FIG. 1a is a graphical representation of a monolayer film of the present invention and FIG. 1b is a graphical representation of a multilayer film of the present invention.

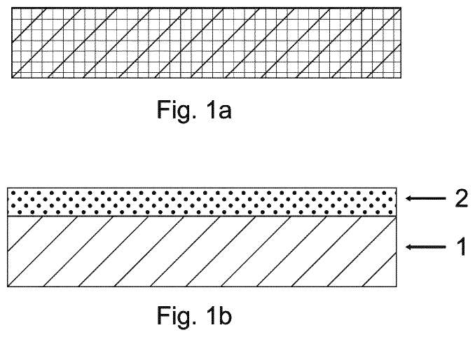

FIG. 2 is a photograph of some of the films of Example 1 laid over printed text, which gives an indication of the transparency of the films.

FIGS. 3a, 3b and 3c are photographs of products wrapped and sealed in film E4 of Example 1. FIG. 3a shows a stock cube, FIG. 3b shows a bar soap and FIG. 3c shows a dishwasher tablet.

### EXAMPLES

### Materials

Pea Protein Isolate (PPI) (80 wt % protein, 4 wt % carbohydrate) (ProEarth P16109) was purchased from Cambridge Commodities Ltd.

Lactic acid (food-grade, >80%) was purchased from Cambridge Commodities Ltd.

Acetic acid (glacial, food grade) was purchased from Fisher Scientific.

Soluble Potato Starch was purchased from APC, East Tame Business Park, Cheshire SK14 4GX, UK.

Vegetable (rapeseed) oil was purchased from Tesco Ltd, UK.

Food-grade Glycerol (APC Pure) was purchased from APC East Tame Business Park, Cheshire SK14 4GX, UK.

### Measurement Methods

### Dispersion Test in Water

A 0.2 g piece of film was placed in 600 mls of boiling water for 3 minutes with an overhead stirrer at 750 rpm positioned off-centre so that it does not touch the film. Observations were made as to the presence or absence of fragments in the water. After this time, the mixture was passed through a 2 mm mesh sieve. The appearance of the residue collected on the sieve, if any, was observed and noted. The fragments of film were carefully removed from the mesh using tweezers and the mass was measured.

Film Tensile Strength and/or % Elongation Test

Films were tested according to ASTM D882-18 Tensile Properties of Thin Plastic Sheeting using a Tinius Olsen 5ST tensile tester with a 100N load cell.

The films to be tested were cut into strips of 8.0 cm by 1.0 cm. The film thicknesses were measured by a micrometer (DML 3701P6 from RDM Test Equipment) at six points (three on each side of the strip being tested) and the results averaged to determine the average cross-sectional thickness. The strips were then conditioned to 76% relative humidity (RH) at 5° C. by leaving the films exposed within a humidity chamber at 76% RH/5° C. for at least 24 hours before testing to ensure they had reached equilibrium. Conditions were measured using commonly available devices such as the Fisherbrand™ Traceable™ Thermometer/Clock/Humidity Monitor. Such conditions are typical for a domestic fridge.

Alternatively, the strips were conditioned to 55% relative humidity at 22° C. using the same method. Such conditions are typical of the humidity encountered in a room temperature packing and storage facility.

In order to test a film, the strip was removed from the humidity chamber and fixed by the parallel clamps of the 5ST test head with a 5 cm gap between the clamps. The upper clamp attached to the load cell was then moved upwards at a constant speed of 50 mm/minute to stretch the film until failure and the force exerted on the load cell recorded. This procedure happened within 1 minute of the film sample being withdrawn from the humidity chamber to minimise any changes in the condition of the film. The tensile strength is the force at failure divided by the average cross-sectional area of the film before conditioning and testing. The % Break Strain is calculated as (length of the film at failure-length of the initial film)/length of the initial film)×100.

### Transparency Test

A 0.09 mm±0.01 mm thick strip of film was placed over printed text and the transparency of the film noted.

### Example 1: Preparation of Films

Monolayer films (E1-E3 and E5) and multilayer films (E4, E6-E11) were prepared according to the procedures described below. Five comparative monolayer films (C1-C5) were also prepared according to the procedures described below.

### Preparation of Starch-Only Monolayer Film C1

### (i) Preparation of Starch Mixture

22.50 g of Soluble Potato Starch was dispersed in 150 g of ambient temperature, deionised water in a 250 ml flask by stirring. 5.625 g of glycerol and 0.23 g of vegetable oil were then added and the suspension stirred. The suspension was then sonicated (high intensity ultrasound) using a Bandelin Sonopuls HD4200 with a TS113 probe for 14 minutes and 15 seconds. The sonicator was set to an amplitude of 95%, with a cycle of 1 second on and 0.2 seconds off. The suspension was stirred throughout the sonication to ensure homogeneity. After the sonication, 0.54 g of lactic acid was added with stirring. There was no additional heating but the energy of the sonication raised the temperature of the mix to over 80° C. by the end of the sonication period. The mix was then placed in a heated ultrasound water bath for 30 minutes at 80° C. to allow the escape of trapped air bubbles.

### (ii) Film Formation

25 ml of the mix produced in step (i) was poured through a tea strainer to remove any remaining large lumps and into a 50 ml Falcon tube. The mix was then further degassed by removing large bubbles with a pipette and placing the Falcon tube in the ultrasound bath at 80° C. for 5 minutes. The mix was removed, allowed to cool to 55° C. and poured onto a flat glass plate with a Mylar surface. The liquid was spread out uniformly over the plate using an RK K control coater model 101 with a knife edge to give a film of uniform thickness of 1000 microns. The glass plate was then placed in an oven at 80° C. for 1 hr. After this time, the film could be peeled off the Mylar surface ready for testing

### Preparation of Pea Protein Isolate (PPI) Monolayer Film C4

### (i) Preparation of PPI Mixture

30 g of water was mixed with 7.5 g Pea Protein Isolate in a tall 250 ml beaker using an overhead stirrer to form a homogenous paste. 70 ml of acetic acid was then added with stirring along with 1.876 g of glycerol. The suspension was then sonicated (high intensity ultrasound) using a Bandelin Sonopuls HD4200 with a TS113 probe for 7 minutes and 30 seconds. The sonicator was set to an amplitude of 50%, with a cycle of 1 second on and 0.2 seconds off. The suspension was stirred intermittently throughout the sonication to ensure homogeneity.

### (ii) Film Formation

25 mL of the mix produced in step (i) was then cast into a film following the procedure described in step (ii) of the preparation of film C1.

### Preparation of Protein-Starch Monolayer Film E1

### (i) Preparation of Starch Mixture

21.38 g of Soluble Potato Starch was dispersed in 142.5 g of ambient temperature, deionised water in a 250 ml flask by stirring. 5.625 g of glycerol and 0.23 g of vegetable oil were then added and the suspension stirred. The suspension was then sonicated (high intensity ultrasound) according to the procedure described in step (i) of the preparation of film C1.

### (ii) Preparation of PPI Mixture

30 g of water was mixed with 7.5 g of Pea Protein Isolate (PPI) in a tall 250 ml beaker using an overhead stirrer to form a homogenous paste. 70 ml of acetic acid was then added with stirring. The mix was then sonicated and processed according to the procedure described in step (i) of the preparation of film C4.

(iii) Preparation of a Protein-Starch Mixture

15 ml of the PPI mix from step (ii) and 0.54 g lactic acid were added to the total starch mix produced in step (i). The combined mix was sonicated for 1 minute using a Sonopuls HD4200, at an amplitude of 50%, with a cycle of 1 second on, 0.2 seconds off. The combined mix was then placed in an ultrasonic bath at 80° C. for 5 minutes to help remove air bubbles.

### (iv) Film Formation

25 mL of the mix produced in step (iii) was then cast into a film according to the procedure described in step (ii) of the preparation of film C1.

### Preparation of Protein-Starch Monolayer Film C2

### (i) Preparation of Starch Mixture

A starch mix was prepared according to the procedure described in step (i) of the preparation of film E1.

### (ii) Preparation of PPI Mixture

A PPI mix was prepared according to the procedure described in step (ii) of the preparation of film E1.

(iii) Preparation of Protein-Starch Mixture

7.5 ml of the PPI mix from step (ii) and 0.54 g lactic acid were then added to the total starch mix from step (i). The combined mix was then sonicated and prepared according to the procedure described in step (iii) of the preparation of film E1.

### (iv) Film Formation

25 mL of the mix produced in step (iii) was then cast into a film according to the procedure described in step (ii) of the preparation of film C1.

Preparation of Protein-Starch Monolayer Film C3 (without Organic Acid Treatment Step)

### (i) Preparation of Starch Mixture

A starch mix was prepared according to the procedure described in step (i) of the preparation of film E1.

### (ii) Preparation of PPI Mix

7.5 g of Pea Protein Isolate (PPI) was added to 100 g of water in a tall 250 ml beaker using an overhead stirrer to form a homogenous paste. The PPI mix was then sonicated according to the procedure described in step (i) of the preparation of film C4.

(iii) Preparation of Protein-Starch Mixture

15 ml of the PPI mix from step (ii) and 0.54 g lactic acid were added to the starch mix from step (i). The combined mix was sonicated for 1 minute using a Sonopuls HD4200, at an amplitude of 50%, with a cycle of 1 second on, 0.2 seconds off. The combined mix was then placed in an ultrasonic bath at 80° C. for 5 minutes to help remove air bubbles.

### (iv) Film Formation

25 mL of the combined mix produced in step (iii) was then cast into a film according to the procedure described step (ii) of the preparation of film C1.

### Preparation of Protein-Starch Monolayer Film E5

### (i) Preparation of Starch Mixture

A starch mix was prepared according to the procedure in step (i) of the preparation of film C1.

### (ii) Preparation of PPI Mixture

A PPI mixture was prepared according to the procedure described in step (i) of the preparation of film C4.

(iii) Preparation of Protein-Starch Mixture

150 ml of the PPI mix from step (ii) and 0.54 g lactic acid were added to the total starch mix from step (i) to form a combined mix. The combined mix was sonicated for 3 minutes using a Bandelin Sonopuls HD4200, at an amplitude of 50% with a cycle of 1 second on, 0.2 seconds off. The combined mix was then placed in an ultrasonic bath at 80° C. for 5 minutes to help remove air bubbles.

### (iv) Film Formation

25 mL of the combined mix from step (iii) was then cast into a film according to the procedure described in step (ii) of the preparation of film C1.

### Preparation of Protein-Starch Monolayer Film E2

### (i) Preparation of Starch Mixture

A starch mix was prepared according to the procedure described in step (i) of the preparation of film C1, except that 19.13 g of starch and 127.50 g of water were used.

### (i) Preparation of PPI Mixture

A PPI mix was prepared according to the procedure described in step (ii) of the preparation of film E1.

(iii) Preparation of Protein-Starch Mixture

45 ml of the PPI mix from step (ii) and 0.54 g lactic acid were added to the starch mix from step (i). The combined mix was sonicated for 3 minutes using a Sonoplus 4000, at an amplitude of 50% with a cycle of 1 second on, 0.2 seconds off. The combined mix was then placed in an ultrasonic bath at 80° C. for 5 minutes to help remove air bubbles.

### (iv) Film Formation

25 mL of the combined mix from step (iii) was then cast into a film according to the procedure described in step (ii) of the preparation of film C1.

### Preparation of Protein-Starch Monolayer Film E3

### (i) Preparation of Starch Mixture

A starch mix was prepared according to the procedure described in step (i) of the preparation of film C1, except that 16.88 g of starch and 112.5 g of water were used.

### (ii) Preparation of PPI Mixture

A PPI mix was prepared according to the procedure described in step (ii) of the preparation of film E1.

(iii) Preparation of Protein-Starch Mixture

75 ml of the PPI mix from step (ii) and 0.54 g lactic acid were added to the starch mix from step (i). The combined mix was sonicated for 3 minutes using a Bandelin Sonopuls HD4200, at an amplitude of 50% with a cycle of 1 second on, 0.2 seconds off. The combined mix was then placed in an ultrasonic bath at 80° C. for 5 minutes to help remove air bubbles.

### (iv) Film Formation

25 mL of the combined mix from step (iii) was then cast into a film according to the procedure described in step (ii) of the preparation of film C1.

### Preparation of Protein-Starch Multilayer Film E4

### (i) Preparation of Starch Mixture

A starch mix was prepared according to step (i) of the preparation of film E1.

### (ii) Preparation of PPI Mixture

A PPI mix was prepared according to step (ii) of the preparation of film E1.

(iii) Preparation of Protein-Starch Mixture

A combined PPI and starch mix was prepared according to step (iii) of the preparation of film E1.

### (iv) Film Formation—First Layer

25 mL of the combined mix from step (iii) was cast into a film according to step (ii) of the preparation of film C1, except that a wet film thickness of 900 microns was applied to Mylar surface of the glass plate. The film was left to dry at 80° C. for 60 minutes.

### (v) Film Formation—Second Layer

Whilst the film of step (iv) was drying, 1.594 g glycerol and 0.064 g of vegetable oil were added to the remaining 85 ml of the PPI mix from step (ii). The mix was sonicated using a Bandelin Sonopuls HD4200 for 2 minutes at 50% amplitude, with a cycle of 1 second on, 0.2 seconds off. The mix was then degassed and cooled to 55° C.

7 ml of the mixture was then spread over the exposed surface (i.e. the surface not in contact with the glass plate) of the dried film prepared in step (iv) using an RK K control coater model 101 with a Tan K-bar of wire diameter 1.52 mm to give a wet film of the PPI mix of approximately 120 microns thickness. The plate was then put back in the oven for 15 minutes at 80° C. to form the multilayer film E4.

Preparation of Protein-Starch Monolayer Film C5 (without Organic Acid Treatment Step)

### (i) Preparation of Starch Mixture

11.25 g of Soluble Potato Starch was dispersed in 75 g of ambient temperature, deionised water in a 250 ml flask by stirring. 5.625 g of glycerol and 0.23 g of vegetable oil were then added and the suspension stirred. The suspension was then sonicated (high intensity ultrasound) using a Bandelin Sonopuls HD4200 with a TS113 probe for 7 minutes and 30 seconds. The sonicator was set to an amplitude of 95% amplitude, with a cycle of 1 second on and 0.2 seconds off. The suspension was stirred throughout the sonication to ensure homogeneity. There was no additional heating but the energy of the sonication raised the temperature of the mix to over 80° C. by the end of the sonication period. The mix was then placed in a heated ultrasound water bath for 30 minutes at 80° C. to allow the escape of trapped air bubbles.

### (ii) Preparation of PPI Mixture

7.5 g of Pea Protein Isolate (PPI) was added to 100 g of water in a tall 250 ml beaker using an overhead stirrer to form a homogenous paste. The PPI mix was then sonicated according to the procedure described in step (i) of the preparation of film C4.

(iii) Preparation of Protein-Starch Mixture

150 ml of the PPI mix from step (ii) and 0.54 g lactic acid were added to the starch mix from step (i). The combined mix was sonicated for 3 minutes using a Bandelin Sonopuls HD4200, at an amplitude of 50% with a cycle of 1 second on, 0.2 seconds off. The combined mix was then placed in an ultrasonic bath at 80° C. for 5 minutes to help remove air bubbles.

### (iv) Film Formation

25 mL of the combined mix from step (iii) was then cast into a film according to the procedure described in step (ii) of the preparation of film C1.

### Preparation of Protein-Starch Multilayer Film E6

### (i) Preparation of Starch Mixture

75 g of Soluble Potato Starch was added to 500 g of ambient temperature, deionised water in a Klarstein food processor (Grand Prix Chef Edition). 21.77 g of glycerol was then added whilst starting the program: Temperature 85° C., Speed 4, 45 mins. After 45 min the solution was taken out of the food processor and poured into a suitable container and degassed using a FlackTek Speedmixer from Synergy with the following parameters: 3 min, 2000 rpm, 50 mBars.

### (ii) Preparation of PPI Mixture

60 g of water was mixed with 15 g of Pea Protein Isolate (PPI) and 3.75 g of glycerol. in a tall 250 ml beaker using an overhead stirrer to form a homogenous paste. 140 ml of acetic acid was then added with stirring. The mix was then sonicated (high intensity ultrasound) using a Bandelin Sonopuls HD4200 with a TS113 probe for 15 minutes. The sonicator was set to an amplitude of 50%, with a cycle of 1 second on and 0.2 seconds off. The suspension was stirred intermittently throughout the sonication to ensure homogeneity. Once sonicated, the slurry was poured into a suitable container and degassed using a FlackTek Speedmixer from Synergy using the following parameters: 2 min, 2000 rpm, 999 mBar.

(iii) Film Formation 1^{st} Layer

The starch mixture from (i) was poured onto a flat glass plate with a Mylar surface. The liquid was spread out uniformly over the plate using an RK K303S Multicoater with a knife edge to give a film of uniform thickness of 500 microns. The glass plate was then placed in an oven at 80° C. for 1 hr. After this time, the film could be peeled off the Mylar surface ready for testing.

### (iv) Film Formation 2^{nd} Layer

7 ml of the mixture (ii) was then spread over the exposed surface (i.e. the surface not in contact with the glass plate) of the dried film prepared in step (iv) using an RK K303S Multicoater with a Black K-bar of wire diameter 0.51 mm to give a wet film of the PPI mix of approximately 40 microns thickness. The plate was then put back in the oven for 15 minutes at 80° C. to form the multilayer film E6.

### Preparation of Protein-Starch Multilayer Film E7

### (i) Preparation of Starch Mixture

128.25 g of Soluble Potato Starch was added to 855 g of ambient temperature, deionised water in a Klarstein food processor (Grand Prix Chef Edition). 39.1 g of glycerol and 1.36 g of vegetable oil was then added whilst starting the program: Temperature 85° C., Speed 4, 45 mins.

### (ii) Preparation of PPI Mixture

30 g of water was mixed with 7.5 g of Pea Protein Isolate (PPI) in a tall 250 ml beaker using an overhead stirrer to form a homogenous paste. 70 ml of acetic acid was then added with stirring. The mix was then sonicated (high intensity ultrasound) using a Bandelin Sonopuls HD4200 with a TS113 probe for 7 minutes and 30 seconds. The sonicator was set to an amplitude of 50%, with a cycle of 1 second on and 0.2 seconds off. The suspension was stirred intermittently throughout the sonication to ensure homogeneity.

(iii) Preparation of Protein-Starch Mixture

90 ml of the PPI mix from step (ii) and 1.60 g lactic acid were added to the total starch mix produced in step (i). The combined mix was stirred for a further 5 minutes. After a total of 50 mins, the combined mix was taken out of the food processor and poured into a suitable container and degassed using a Flacktek Speedmixer from Synergy with the following parameters: 3 min, 2000 rpm; 50 mBars.

### (iv) Film Formation—First Layer

Once degassed the mix from step (iii) was poured onto a flat glass plate with a Mylar surface. The liquid was spread out uniformly over the plate using an RK K303S Multicoater with a knife edge to give a film of uniform thickness of 900 microns. The glass plate was then placed in an oven at 80° C. for 1 hr.

### (v) Film Formation—Second Layer

Whilst the film of step (iv) was drying, 37.5 g of water was mixed with 9.38 g of Pea Protein Isolate (PPI) and 2.72 g of glycerol in a tall 250 ml beaker using an overhead stirrer to form a homogenous paste. 88 ml of acetic acid was then added with stirring. The mix was then sonicated (high intensity ultrasound) using a Bandelin Sonopuls HD4200 with a TS113 probe for 9 minutes and 22 seconds. The sonicator was set to an amplitude of 50%, with a cycle of 1 second on and 0.2 seconds off. The suspension was stirred intermittently throughout the sonication to ensure homogeneity.

7-15 ml of the mixture was then spread over the exposed surface (i.e. the surface not in contact with the glass plate) of the dried film prepared in step (iv) using an RK K303S Multicoater with a Brown K-bar of wire diameter 1.02 mm to give a wet film of the PPI mix of approximately 80 microns thickness. The plate was then put back in the oven for 15 minutes at 80° C. to form the multilayer film E7.

### Preparation of Starch-Protein Multilayer Film E8

### (i) Preparation of Starch Mixture

500 ml of deionised water was mixed with 50 g of potato starch in a 600 ml beaker at ambient temperature using an overhead stirrer. 21.43 g of glycerol was then added and the suspension stirred. The suspension was then sonicated (high intensity ultrasound) using a Bandelin Sonopuls HD4200 with a TS113 probe for 50 minutes at an amplitude of 95%, with a cycle of 1 second on, 0.2 seconds off. The suspension was stirred throughout the sonication to ensure homogeneity. The solution was then placed in a sonicator bath for 30 minutes at 80° C. to remove any bubbles.

### (ii) Film Formation—Starch Layer

25 ml of the mix produced in step (i) was poured into a 50 ml Falcon tube. The mix was then further degassed by removing large bubbles with a pipette and placing the Falcon tube in the ultrasound bath at 80° C. for 5 minutes, before being removed and allowed to cool to 55° C. The liquid was poured onto a flat glass plate having a Mylar surface and was spread out uniformly over the plate using a knife blade to give a wet film thickness of 500 microns. The glass plate was then put in the oven for 60 minutes at 80° C. to form the dried film layer.

(iii) Preparation of Protein Mixture

150 g of water was mixed with 37.5 g of Pea Protein Isolate (PPI) at ambient temperature in a 600 ml beaker using an overhead stirrer to form a homogenous paste. 350 ml of acetic acid and 10.89 g of glycerol were then added with stirring. The mix was then sonicated (high intensity ultrasound) using a Bandelin Sonopuls HD4200 with a TS113 probe for 37 minutes and 30 seconds. The sonicator was set to an amplitude of 50%, with a cycle of 1 second on and 0.2 seconds off. The suspension was stirred intermittently throughout the sonication to ensure homogeneity.

### (iv) Film Formation—Protein Layer

25 ml of the mix produced in step (iii) was poured into a 50 ml Falcon tube. The mix was then degassed by removing large bubbles with a pipette, and placing the Falcon tube in the ultrasonic bath at 80° C. for 1 minute before being allowed to cool to 55° C. and then spread over the exposed surface (i.e. the surface not in contact with the glass plate) of the dried film prepared in step (ii) using a knife blade to give a wet film of the PPI mix of approximately 500 microns thickness. The plate was then put in the oven for 30 minutes at 80° C. to form the multilayer film.

### Preparation of Starch-Protein Multilayer Film E9

### (i) Preparation of Starch Mixture

500 ml of deionised water was mixed with 50 g of potato starch in a 600 ml beaker at ambient temperature using an overhead stirrer. 21.43 g of glycerol was then added and the suspension stirred. The suspension was then sonicated (high intensity ultrasound) using a Bandelin Sonopuls HD4200 with a TS113 probe for 50 minutes. The sonicator was set to an amplitude of 95%, with a cycle of 1 second on and 0.2 seconds off. The suspension was stirred throughout the sonication to ensure homogeneity. There was no additional heating but the energy of the sonication raised the temperature of the mix to over 80° C. by the end of the sonication period. The mix was then placed in a heated ultrasound water bath for 30 minutes at 80° C. to allow the escape of trapped air bubbles.

### (ii) Film Formation—Starch Layer

15 mL of the mix from step (i) was poured into a 50 ml Falcon tube. The mix was then further degassed by removing large bubbles with a pipette and placing the Falcon tube in the ultrasound bath at 80° C. for 5 minutes, before being removed and allowed to cool to 55° C. The liquid was poured onto a flat glass plate having a Mylar surface and was spread out uniformly over the plate using an RK K control coater model 101 with a knife blade to give a wet film thickness of 300 microns. The film was left to dry at 80° C. for 30 minutes.

(iii) Preparation of Protein Mixture

150 ml of deionised water was mixed with 37.5 g of PPI at ambient temperature in a 600 ml beaker using an overhead stirrer to form a homogenous paste. 350 ml of acetic acid and 10.89 g of glycerol were then added with stirring. The mix was then sonicated (high intensity ultrasound) using a Bandelin Sonopuls HD4200 with a TS113 probe for 37 minutes and 30 seconds. The sonicator was set to an amplitude of 50%, with a cycle of 1 second on and 0.2 seconds off. The suspension was stirred intermittently throughout the sonication to ensure homogeneity.

### (iv) Film Formation—Protein Layer

25 ml of the mix from step (iii) was poured into a 50 ml Falcon tube. The mix was then degassed by removing large bubbles with a pipette, and placing the Falcon tube in the ultrasonic bath at 80° C. for 1 minute before being allowed to cool to 55° C. and then spread over the exposed surface (i.e. the surface not in contact with the glass plate) of the dried film prepared in step (ii) using an RK K control coater model 101 with a knife blade to give a wet film of the PPI mix of approximately 500 microns thickness. The plate was then put in the oven for 30 minutes at 80° C. to form the multilayer film.

### Preparation of Starch-Protein Multilayer Film E10

### (i) Preparation of Starch Mixture

2000 ml of deionised water at ambient temperature was mixed with 85.7 g of glycerol, in a Klarstein food processor (Grand Prix Chef Edition). 200 g of potato starch was then added whilst starting the program: Temperature 85° C., Speed 4, 45 mins. The batch was then moved to a VEVOR vacuum chamber connected to a ¼ hp 3 cfm single stage vacuum pump for degassing. The material was poured in the container, which was then sealed, and the vacuum pump operated for 5-10 min until the slurry was free of air bubbles.

### (ii) Film Formation—Starch Layer

The casting of the starch layer took place using a standard roll to roll machine including a pressure vessel, a fluid pump, a slot die unit, a feeding roller, a web traversing a series of rollers and load cells that allowed tension control, a drying oven of approximately 2 meters length and a winding roller. The backing used for this casting was a standard 72 μm PET roll. The starch mixture prepared in (i) was poured into the pressure vessel and then tightly closed making sure there were no leaks. The vessel was then pressurised to 1-2 bar and the starch mixture was pumped through the progressive cavity pump to feed the slot die. The equipment was set to the following parameters:
Oven temperature: 100-140° C.
Line speed: 0.4-1m/min
Slot die width: 300 mm
Fluid pump flow: 50-120 ml/min
Slot die distance from backing: 0.2-0.4 mm
Shim distance between slot lips: 150-200 μm
   The wet thickness was varied between 300 and 550 μm and was tuned to approximately 350 μm by adjusting the parameters. The film came out of the oven dry and the resulting roll was then moved from the collection winder and placed as the feed roll so that a second film could be cast on top of it.
   (iii) Preparation of Protein Mixture

740 g of water was mixed with 94.4 g of Pea Protein Isolate (PPI) in a tall 1000 ml beaker using an overhead stirrer to form a homogenous slurry. 60 g of acetic acid and 23.6 g of glycerol were then added while stirring. The mix was placed in a 90° C. water bath for 20-30 min with shaking every 10 min. Following this step, the slurry was transferred to a Hielscher 1 KW sonicator (with booster) and an energy total of 200 kJ was applied with shaking every ˜30 min. Sonication took approximately 30 mins to reach the target energy. The process was repeated 3 times to produce a total of 2400 ml of product which was then degassed using a using a Flacktek Speedmixer from Synergy with the settings of 3-5 min, 2000 rpm; 50 mBars.

### (iv) Film Formation—Protein Layer

The coating equipment as described in step (ii) was used for this layer; however, the backing already had the first layer of starch coated on it. The protein mixture prepared in step (iii) was poured in the pressurized vessel and the coater was set to the following parameters:
Oven temperature: 100-130° C.
Line speed: 0.7-1m/min
Slot die width: 300 mm
Fluid pump flow: 40-120 ml/min
Slot die distance from backing: 0.2-0.25 mm
Shim distance between slot lips: 150-200 μm
   The multilayer film came out of the oven dry and showed minimal bubbles and/or imperfections. Each of the two layers had a thickness of approximately 30 μm.

### Preparation of Starch-Protein Multilayer Film E11

### (i) Preparation of Starch Mixture

A starch mix was prepared according to the procedure described in step (i) of the preparation of film E10.

### (ii) Film Formation—Starch Layer

2000 ml of the batch described in step (i) was cast into a roll of film according to the procedure described in step (ii) of the preparation of film E10.

(iii) Preparation of Protein Mixture

1200 g of deionised water was measured and poured into a large 3 L stainless steel vessel. The vessel was placed in a water bath set at 95° C. and an overhead stirrer with an impeller blade was used to mix the water at 900 rpm. 320 g of pea protein isolate was added to the mixture and left to stir for 3 min until a homogenous mix was formed. 800 g of acetic acid was measured and poured into the mix which was stirred at 700 rpm for 40 min. The temperature of the mix was measured to ensure it had reached 85° C. and if necessary, the stirring continued to ensure that the mix had reached 85° C. for at least 10 min. Following that, the mix was sheared using a Silverson high shear homogeniser at 7000 rpm for 3 min.

The freshly shear mixed slurry was then poured into plastic flat containers or large petri dishes to an approximate height of 10 mm. The containers were then sealed and stored in a fridge for 16-28 hours.

After storage, the gel that formed was cut into 1 cm×1 cm squares and using a spatula, the gel cubes were transferred in a 75 μm filter bag. The bag was then suspended with the gel cubes in a bucket containing 61 of reverse osmosis water. After 1h 30 min, 31 of water were removed and replaced with 31 of fresh reverse osmosis water. The bag and gel cubes were left in the water and swirled every 20 min for 90-150 min. The pH was measured and if below 2.9 then the previous two steps were repeated until the pH reached values above 2.9.

The filter bag was then raised from the water and squeezed vigorously to remove as much excess water as possible. The slurry was then transferred to a 11 container and using an Ultra-Turrax mixer the gel mush was sheared at 15000 rpm for 15 min with shaking every 5 min. 21.71 g of glycerol was then added to the mixture followed by another 5 min of Ultra-Turrax mixing at 15000 rpm. The container was then placed in an ice bath and the mix was sonicated with a Hielschler sonicator until 0.25 kJ/ml was achieved. The slurry was filtered through a 212 μm mesh and stored in plastic buckets.

### (iv) Film Formation—Protein Layer

2000 ml of the mixture prepared in step (iii) was poured in the pressurised vessel of the coater described in step (iv) of film E10. The following parameters were used to set up the equipment:
Oven temperature: 100-115° C.
Line speed: 0.5-0.9 m/min
Slot die width: 300 mm
Fluid pump flow: 50-90 ml/min
Slot die distance from backing: 0.15-0.2 mm
Shim distance between slot lips: 150-200 μm
   The multilayer film came out of the oven dry and showed minimal bubbles and/or imperfections. Each of the two layers had a thickness of approximately 30 μm.

The compositions of each of the prepared films are shown in Table 1.

TABLE 1
(misc = insoluble fibres)

| | | | | Starch to Protein |
|---|---|---|---|---|
| Film No. | Film type | Film composition, % wt | | weight ratio |
| C1 | Monolayer | Protein | 0.0 | N/A |
| | | Total starch | 67.4 | |
| | | Vegetable oil | 0.7 | |
| | | Glycerol | 16.8 | |
| | | Lactic acid | 1.6 | |
| | | Acetic acid | 0.0 | |
| | | Water | 13.5 | |
| | | Misc | 0.0 | |
| C2 | Monolayer | Protein | 1.3 | 49.8:1 |
| | | Total starch | 65.4 | |
| | | Vegetable oil | 0.7 | |
| | | Glycerol | 16.6 | |
| | | Lactic acid | 1.6 | |
| | | Acetic acid | 0.2 | |
| | | Water | 13.9 | |
| | | Misc | 0.3 | |
| C3 | Monolayer | Protein | 2.6 | 23.8:1 |
| | | Total starch | 63.7 | |
| | | Vegetable oil | 0.7 | |
| | | Glycerol | 16.7 | |
| | | Lactic acid | 1.6 | |
| | | Acetic acid | 0.0 | |
| | | Water | 14.1 | |
| | | Misc | 0.5 | |
| E1 | Monolayer | Protein | 2.7 | 23.8:1 |
| | | Total starch | 64.2 | |
| | | Vegetable oil | 0.7 | |
| | | Glycerol | 16.9 | |
| | | Lactic acid | 1.6 | |
| | | Acetic acid | 0.2 | |
| | | Water | 13.1 | |
| | | Misc | 0.5 | |
| E2 | Monolayer | Protein | 8.1 | 7.1:1 |
| | | Total starch | 57.9 | |
| | | Vegetable oil | 0.7 | |
| | | Glycerol | 16.9 | |
| | | Lactic acid | 1.6 | |
| | | Acetic acid | 0.5 | |
| | | Water | 12.7 | |
| | | Misc | 1.6 | |
| E3 | Monolayer | Protein | 13.5 | 3.8:1 |
| | | Total starch | 51.5 | |
| | | Vegetable oil | 0.7 | |
| | | Glycerol | 16.9 | |
| | | Lactic acid | 1.6 | |
| | | Acetic acid | 0.8 | |
| | | Water | 12.3 | |
| | | Misc | 2.7 | |
| E4 | Multilayer | Protein | 13.4 | 3.9:1 |
| | | Total starch | 52.0 | |
| | | Vegetable oil | 0.7 | |
| | | Glycerol | 17.0 | |
| | | Lactic acid | 1.3 | |
| | | Acetic acid | 0.8 | |
| | | Water | 12.2 | |
| | | Misc | 2.7 | |
| E5 | Monolayer | Protein | 27.3 | 1.3:1 |
| | | Total starch | 35.5 | |
| | | Vegetable oil | 0.7 | |
| | | Glycerol | 17.0 | |
| | | Lactic acid | 1.6 | |
| | | Acetic acid | 1.6 | |
| | | Water | 10.9 | |
| | | Misc | 5.5 | |
| C4 | Monolayer | Protein | 56.5 | 0.05:1 |
| | | Total starch | 2.8 | |
| | | Vegetable oil | 0.0 | |
| | | Glycerol | 17.6 | |
| | | Lactic acid | 0.0 | |
| | | Acetic acid | 3.3 | |
| | | Water | 8.5 | |
| | | Misc | 11.3 | |
| C5 | Monolayer | Protein | 25.3 | 1.3:1 |
| | | Total starch | 32.8 | |
| | | Vegetable oil | 0.6 | |
| | | Glycerol | 15.8 | |
| | | Lactic acid | 1.5 | |
| | | Acetic acid | 0.0 | |
| | | Water | 18.9 | |
| | | Misc | 5.1 | |
| E6 | Multilayer | Protein | 9.40 | 6:1 |
| | | Total starch | 56.40 | |
| | | Vegetable oil | 0.00 | |
| | | Glycerol | 19.20 | |
| | | Lactic acid | 0.00 | |
| | | Acetic acid | 0.55 | |
| | | Water | 12.60 | |
| | | Misc | 1.88 | |
| E7 | Multilayer | Protein | 6.45 | 9.1:1 |
| | | Total starch | 58.70 | |
| | | Vegetable oil | 0.62 | |
| | | Glycerol | 19.29 | |
| | | Lactic acid | 0.62 | |
| | | Acetic acid | 0.38 | |
| | | Water | 12.65 | |
| | | Misc | 1.29 | |
| E8 | Multilayer | Protein | 27.45 | 1.1:1 |
| | | Total starch | 30.30 | |
| | | Vegetable oil | 0.00 | |
| | | Glycerol | 22.36 | |
| | | Lactic acid | 0.00 | |
| | | Acetic acid | 1.60 | |
| | | Water | 12.80 | |
| | | Misc | 5.49 | |
| | | Protein | 34.32 | |
| | | Total starch | 23.41 | |
| | | Vegetable oil | 0.00 | |
| E9 | Multilayer | Glycerol | 21.75 | 0.68:1 |
| | | Lactic acid | 0.00 | |
| | | Acetic acid | 2.00 | |
| | | Water | 11.66 | |
| | | Misc | 6.86 | |
| E10 | Multilayer | Protein | 26.88 | 1.1:1 |
| | | Total starch | 30.27 | |
| | | Vegetable oil | 0.00 | |
| | | Glycerol | 20.80 | |
| | | Lactic acid | 0.00 | |
| | | Acetic acid | 0.11 | |
| | | Water | 16.58 | |
| | | Misc | 5.38 | |
| E11 | Multilayer | Protein | 32.85 | 0.88:1 |
| | | Total starch | 28.93 | |
| | | Vegetable oil | 0.00 | |
| | | Glycerol | 22.21 | |
| | | Lactic acid | 0.00 | |
| | | Acetic acid | 0.06 | |
| | | Water | 15.95 | |
| | | Misc | 0.00 | |

### Example 2: Properties of Films

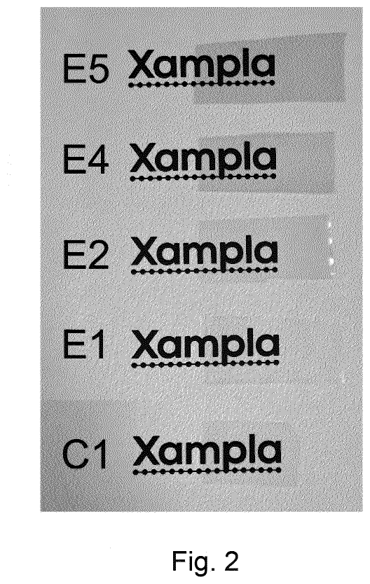

The films prepared in Example 1 were then tested to determine their physical properties. The tests methods used to determine dispersion properties, tensile strength, % break strain and transparency are detailed above in the measurement methods section and the results are shown in Tables 2a, 2b, 3 and 4 or, in the case of the transparency test, in FIG. 2.

TABLE 2a
Tensile Strength and % Break Strain of films conditioned at 5°
C. and 76% RH (Film C2 did not form a viable film that could
be subjected to the tensile strength or break strain tests)

| Film | Tensile Strength | % Break |
|---|---|---|
| No. | (MPa) | Strain |
| C1 | 0.09 | 202 |
| E1 | 0.17 | 73.8 |
| E2 | 0.26 | 75.3 |
| E3 | 0.56 | 47.5 |
| E5 | 3.70 | 120 |
| C4 | 2.03 | 23.9 |
| E4 | 1.41 | 18.6 |
| E6 | 1.20 | 147 |
| E7 | 0.50 | 117 |
| E8 | 1.82 | 34.5 |
| E9 | 1.81 | 34.0 |

The results in Table 2a show that a film that contains no plant protein (C1) has a very low tensile strength combined with a very high % break strain making it very difficult to handle and process into the desired form, e.g. under industrial conditions. A film that contains almost no starch (C4) has a good tensile strength but much reduced % break strain, indicating that the film is brittle. Again, this makes the film harder to process, e.g. under industrial conditions.

The data also demonstrates that addition of plant protein (PPI) to starch (as in E1, E2, E3, E5) increases the film tensile strength and reduces the % break strain to an optimal level such that the films can be used to coat or enclose a product.

The data also demonstrates that a film prepared as a multilayer (E4) has increased tensile strength versus a film having the same starch:protein weight ratio prepared as a monolayer (E3).

The data also demonstrates that films prepared as a multilayer with higher ratios of starch to plant protein (PPI) (E6 & E7) have adequate tensile strength and % break strain.

The data also demonstrates that films prepared as multilayers with lower ratios of starch to plant protein (PPI) (E8 & E9) have good tensile strength and % break strain.

TABLE 2b
Tensile Strength and % Break Strain of
films conditioned at 22° C. and 55% RH

| | Tensile Strength | % Break |
|---|---|---|
| Film No. | (MPa) | Strain |
| E8 | 12.50 | 14.3 |
| E9 | 6.40 | 90.6 |
| E10 | 8.30 | 18.7 |
| E11 | 8.84 | 29.6 |

The results in Table 2b demonstrate that films with a lower ratio of starch:protein and with lower level of acetic acid, such as E10 and E11, still have good tensile strength and elongation at 22° C. and 55% RH when compared to similar films with higher acetic acid, E8 and E9.

TABLE 3
Tensile Strength and % Break Strain of films
with and without protein acid pre-treatment

| | | Tensile | | | Tensile | |
|---|---|---|---|---|---|---|
| | | Strength | % Break | | Strength | % Break |
| Film | Appearance | (MPa) | Strain | Appearance | (MPa) | Strain |
| No. | 5° C. 76% RH | | | 22° C. 55% RH | | |
| E1 | Transparent | 0.17 | 73.8 | Transparent | 2.99 | 114 |
| C3 | Transparent | 0.16 | 36.6 | Transparent | 2.81 | 72.5 |
| E5 | Transparent | 3.70 | 119.7 | Transparent | 3.42 | 129.00 |
| C5 | Translucent, | N/A | N/A | Translucent, | N/A | N/A |
| | excessive | | | excessive | | |
| | cracking on | | | cracking on | | |
| | drying | | | drying | | |

Table 3 shows the effect of protein organic acid pre-treatment. For a low level of protein compared to starch, as in films E1 and C3, at both cold and room temperatures, the % break strain is higher with organic acid pre-treatment of the protein whilst the tensile strength is unchanged. This results in a film that is less brittle and easier to process as a packaging material.

The data also demonstrates that as the protein level in the film increases it becomes increasingly difficult to prepare a transparent film that does not crack upon drying, as can be seen for C5 which did not produce a viable film that could be tested. However, a film made from the same composition but with organic acid-treated protein, E5, is a transparent film with good tensile strength and % break strain, resulting in a film which is robust and can be easily handled.

TABLE 4
Dispersion test results

| Film | | Dispersion test - |
|---|---|---|
| No. | Dispersion test - appearance | mass of residue on sieve |
| C1 | Dissolved | No residue |
| C2 | Dissolved, a few small fragments | No measurable residue |
| E1 | Dissolved | No measurable residue |
| E2 | Dispersed - some small fragments | 0.05 g residue |
| E3 | Dispersed - multiple fragments | 0.15 g residue |
| E4 | Dispersed - multiple fragments | 0.15 g residue |
| C4 | No dispersion/film did not break up | 0.44 g residue |
| E6 | Dissolved, a few small fragments | 0.09 g residue |
| E7 | Dispersed - Multiple fragments | 0.22 g residue |

A comparative film with no plant protein (C1) is highly soluble. A comparative film mainly containing plant protein (C4) is not soluble and does not disperse resulting in a residue of 0.44 g. The presence of low levels of protein in the monolayer film (E1, E2, E3, E4) results in a film that is either water-dissolvable or water-dispersible and leaves not greater than 0.15 g of residue behind on the sieve in a dispersion test.

Comparison of the data for films E3 and E4 demonstrate that the dispersibilty is equally good whether the film is a homogeneous monolayer film or a multilayer film.

Multilayer films with higher ratios of starch to plant protein (E6 and E7) also demonstrate good dissolution or dispersibility with a residue of less than 0.22 g, less than that of the comparative protein only film C4. The dispersion test residue for E6 is particularly low because of the low overall film thickness compared to E7.

FIG. 2 is a photograph of some of the films of Example 1 laid over printed text, which gives an indication of the transparency of the films. The images show that a film that contains no plant protein (C1) is highly transparent. As the level of protein in the film increases (E1, E2, E4, E5), the films still have a good transparency, this being a useful feature of a packaging material.

### Example 3: Use of Films to Coat/Enclose a Product

### Protocol for Coating/Enclosing Dishwasher Tablets and Stock Cubes:

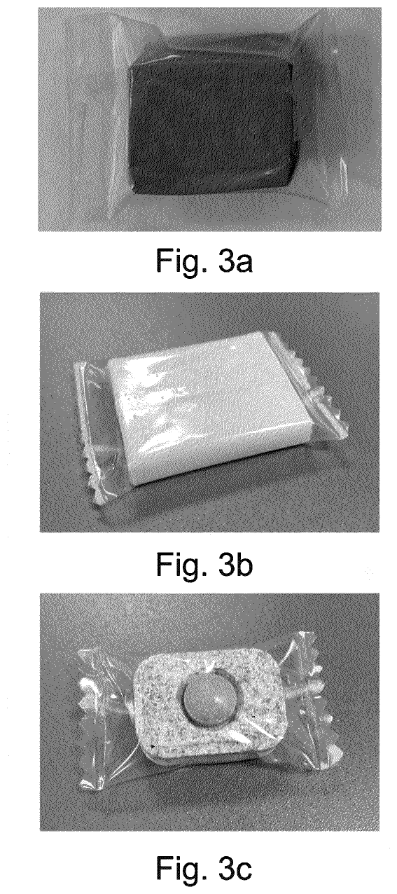

A 90×60 mm piece of film E4 was cut with a sharp knife. The two long edges were folded such that the starch layer was inside and the edges were then sealed together with a RS PRO Heat Sealer (300 mm) on Setting 2. A dishwasher or stock cube tablet was then placed inside the semi-formed flow wrap. The Tablet was then centred and the film sealed on both edges. Any excess material was cut away. FIG. 3a shows a stock cube enclosed in a sealed sachet of film E4 whilst FIG. 3c shows a dishwasher tablet enclosed in a sealed sachet of film E4.

### Protocol for the Sample Making of Soap Bar Tablets:

A 150×80 mm piece of film E4 was cut with a sharp knife. The two long edges were folded such that the starch layer was inside and the edges were sealed together with a RS PRO Heat Sealer (300 mm) on Setting 2. A soap bar was placed inside the semi-formed flow wrap. The tablet was then centred and the film sealed on both edges. Any excess material was cut away. FIG. 3b shows a soap bar enclosed in a sealed sachet of film E4.

The results show that the films of the present invention can be used to effectively coat/enclose a variety of products and therefore that they have a useful application as packaging materials.

1. A film, preferably an edible film, comprising greater than or equal to 50 wt % of a combination of a plant protein and starch, based upon the total weight of the film at 55% relative humidity and 22° C., wherein the weight ratio of starch to plant protein is in the range 0.5:1 to 30:1, and wherein the plant protein has been pre-treated with an organic acid.

2. A film as claimed in claim 1, comprising:
a first layer comprising starch; and
a second layer comprising a plant protein, wherein the plant protein has been pre-treated with an organic acid;
wherein the second layer is in contact with a first surface of the first layer.

3. A film according to claim 2, wherein the first layer further comprises a plant protein, wherein the plant protein has been pre-treated with an organic acid.

4. A film according to claim 2 or claim 3, wherein the second layer further comprises starch.

5. A film as claimed in any one of claims 1 to 4, wherein the weight ratio of starch to plant protein is in the range 2:1 to 27.5:1, more preferably 3.5:1 to 25:1, even more preferably 7:1 to 25:1.

6. A film as claimed in any one of claims 1 to 4, wherein the weight ratio of starch to plant protein is in the range 1:2 to 3:1, more preferably 1:1 to 2:1.

7. A film as claimed in any one of claims 1 to 6, wherein the plant protein is selected from soybean protein, pea protein, rice protein, potato protein, rapeseed protein, sunflower protein, preferably selected from pea protein, potato protein, rapeseed protein, sunflower protein and/or rice protein, preferably wherein the plant protein is pea protein.

8. A film as claimed in any one of claims 1 to 7, comprising 2.0 to 40 wt % plant protein based upon the total weight of the film at 55% relative humidity and 22° C.

9. A film as claimed in any one of claims 1 to 8, wherein the starch is selected from wheat starch, potato starch, pea starch, waxy potato starch, maize starch, waxy maize starch, high amylose maize starch, tapioca starch, cassava starch, rye starch, sorghum starch, chickpea starch, soy starch, a modified starch, or a mixture thereof, preferably wherein the starch is potato starch.

10. A film as claimed in any one of claims 1 to 9, comprising 30 to 70 wt % starch based upon the total weight of the film at 55% relative humidity and 22° C.

11. A film as claimed in any one of claims 1 to 10, comprising 8 to 20 wt % water based upon the total weight of the film at 55% relative humidity and 22° C.

12. A film as claimed any one of claims 1 to 11, further comprising a plasticiser, preferably wherein the plasticiser is selected from glycerol, polyethylene glycol, propylene glycol, sorbitol, mannitol, xylitol, triethyl citrate, fatty acids, glucose, mannose, fructose, sucrose, urea, lecithin, waxes, amino acids and organic acids, or a mixture thereof, more preferably wherein the plasticiser is glycerol.

13. A film as claimed in claim 12, comprising 5 to 30 wt % plasticiser based upon the total weight of the film at 55% relative humidity and 22° C.

14. A film as claimed in any one of claims 1 to 13, further comprising a pigment or dye, preferably wherein the pigment or dye is a food colourant, preferably a food colourant derived from plant sources, more preferably a food colourant selected from carotenoids, chlorophyllins, anthocyanins and betanin.

15. A film as claimed in any one of claims 1 to 14, further comprising a structural reinforcement agent, preferably wherein the structural reinforcement agent is selected from cellulosic materials, including microcrystalline cellulose, micro-fibrillated celluloses included cellulose fibres extracted from the pulp of citrus fruits, microfibrous cellulose from fermentation, starch microcrystals, clays or a mixture thereof, preferably micro-fibrillated cellulose from citrus pulp.

16. A film as claimed in claim 15, comprising 0.5 to 5 wt % of said structural reinforcement agent based upon the total weight of the film at 55% relative humidity and 22° C.

17. A film as claimed in any one of claims 1 to 16, further comprising a hydrophobic agent, preferably wherein the hydrophobic agent is a plant-based oil or a plant-based fatty acid.

18. A film as claimed in claim 17, comprising 0.3 to 2.5 wt % of a hydrophobic agent based upon the total weight of the film at 55% relative humidity and 22° C.

19. A film as claimed in any one of claims 1 to 18, wherein the organic acid used in the pre-treatment is selected from acetic acid, an α-hydroxy acid, and a β-hydroxy acid.

20. A film as claimed in any one of claims 2 to 19, wherein the plant protein in the second layer has a protein secondary structure with at least 40% intermolecular β-sheet, at least 50% intermolecular β-sheet, at least 60% intermolecular β-sheet, at least 70% intermolecular β-sheet, at least 80% intermolecular β-sheet, or at least 90% intermolecular β-sheet.

21. A process for preparing a film as claimed in claim 1, comprising the steps of:
(i) mixing the starch in water, optionally with sonication, to form a starch mixture;
(ii) dissolving the plant protein in water and an organic acid, optionally with sonication, to form a protein solution;
(iii) mixing the starch mixture and the protein solution to form a film-forming composition; and
(iv) forming the film-forming composition into a film.

22. A process for preparing a film as claimed in claim 2, comprising the steps of:
(i) mixing the starch in water, optionally with sonication, to form a starch mixture;
(ii) forming the starch mixture into a first layer on a surface;
(iii) dissolving the plant protein in water and an organic acid, optionally with sonication, to form a protein solution; and
(iv) forming the protein solution into a second layer on a first surface of the first layer.

23. A product, preferably a foodstuff, coated with or enclosed by a film according to any one of claims 1 to 20.

24. A product as claimed in claim 23, which is a stock cube.

25. A product as claimed in claim 23, which is a powdered food.

26. A method of coating or enclosing a product, preferably a foodstuff, comprising the steps of:
(i) wrapping the product in a film as claimed in any one of claims 1 to 20; and
(ii) sealing the film around the product.

27. Use of a film according to any one of claims 1 to 20 to coat or enclose a product, preferably a foodstuff.

28. A method of releasing a product coated or enclosed with a film as claimed in any one of claims 1 to 20, comprising the steps of:
(i) placing the coated or enclosed product in water; and
(ii) allowing the film to disperse, thereby releasing the product.

29. A method as claimed in claim 28, wherein the product is released during a cooking process or a washing process.

30. A film-forming composition, preferably an edible film-forming composition, wherein the weight ratio of starch to plant protein is in the range 0.5:1 to 30:1, and wherein the plant protein has been pre-treated with an organic acid.
